(19) United States
(12) Patent Application Publication
(10) Pub. No.: US 2026/0102899 A1
(43) Pub. Date: Apr. 16, 2026

(54) Portable Latched ToolBox

(71) Applicant: Enrique Perez, Oxford, PA (US)

(72) Inventor: Enrique Perez, Oxford, PA (US)

(21) Appl. No.: 19/356,150

(22) Filed: Oct. 12, 2025

Related U.S. Application Data
(60) Provisional application No. 63/707,315, filed on Oct. 15, 2024.

(51) Int. Cl. B25H 3/02

(52) U.S. Cl. CPC B25H 3/023

(57) ABSTRACT

A mobile toolbox assembly for storing and accessing tools while actively working on a project. In one orientation, the toolbox forms a four-sided polygon with a latching lid hinged to a side panel for access to the inside space. In another orientation, the toolbox unlatches at its panels to unfold into a mobile tool access surface to provide a display of required tools. Wheels secured to the bottom panel surface provide mobility in either orientation.

### CROSS REFERENCE TO RELATED APPLICATIONS

This application is a US national application which claims benefit of and priority to U.S. Provisional Ser. No. 63/707,315 , filed 15 Oct. 2024, now pending, the disclosures of which are herein incorporated by reference in its entirety.

### FIELDS OF THE INVENTION

The present invention relates to a mobile toolbox and more particularly to a toolbox that can be stored and moved in a locked configuration capable of accessing to selected tool by opening into a display of organized panels each containing suitably organized tools.

### BACKGROUND

Conventional toolboxes may include designs with multiple panels each individually manufactured and assembled to form a toolbox. Many toolbox designs contain drawers with multiple fasteners attach to pull-out panels where each forms a secure space for tool enclosure or display in an area within the toolbox and depending upon various tool storage. The toolbox sometimes contains a large internal space with several partitions to divide the space into multiple chambers for holding various hand tools. A lack of tool organization and continued searching for the appropriate tool can result in wasted time and frustration. Further, most hand tools are made of metal which can make the tools in the toolbox very heavy and hard to move when the toolbox is full of hand tools.

The present invention provides an alternate design to allow all of the needed tools to be displayed and easily accessible to the user within a short working distance to allow for efficient tool selection while actively working.

### SUMMARY

In accordance with one aspect of the present invention, the toolbox includes at least one box shape orientation having a front panel, a back panel, and two side panels all hinged to a moveable bottom panel with the back panel further hinged to a top panel. Each inner surface of the panels contains a latching means to secure selected tools, oriented for access to a particular task. In one embodiment, the front, back and two side panels are latched together to form an internal tool storage enclosed space such that the hinged top panel functions as a lid to secure the entire toolbox, containing all of the tools to be stored. In another embodiment, all six panels are unlatched and openly displayed through the hinged orientation to form a contiguous flat surface on the floor of the working area. A moveable bottom panel contains a wheeling means such as wheel casters positioned on each corner of the undersurface of the bottom panel that allows mobility for the entire flat surface and displays all the tools for easy access.

Further benefits and advantages of the present invention will become apparent after a careful reading of the detailed description with appropriate reference to the accompanying drawings.

### DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1. Perspective view of the toolbox having the panels and top latched in a closed and latched position.

FIG. 2. Top view of the toolbox showing the hinged top lid panel unlatched and open with latched front, sides and back panels forming internal storage space for tool access.

FIG. 3. The open position of all the panels is shown unlatched to form an contiguous flat surface on all the inner panels for tool display and access while working.

FIG. 4. Bottom underside view showing the caster wheels attached for toolbox movement when the toolbox is positioned on a work surface.

FIG. 5. Toolbox in closed orientation having telescoping handle. Panel A shows the telescoping handle for in latched orientation. Panel B shows an unlatched orientation having an attachment of a telescoping handle with articulating shafts repositioned to support the lid for the top panel.

### DETAILED DESCRIPTION OF THE INVENTION

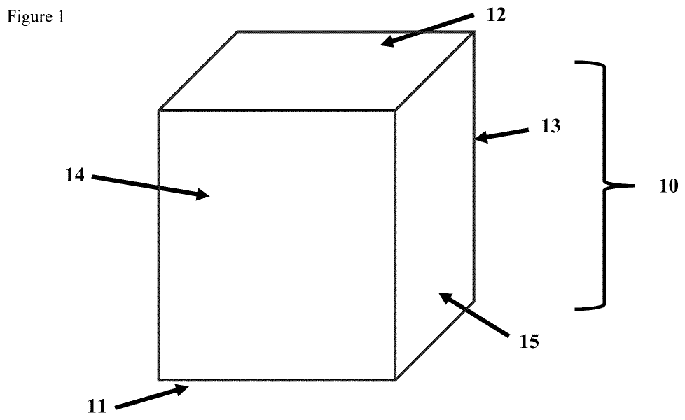

With reference to the drawings and FIGS. 1, 2, 3, 4 and 5, a toolbox is provided in accordance with the present invention comprising at least one box shape (10) in one orientation having an open or closed formation where each includes a top panel (12) hinged to a back panel (13) also separately hinged with a front panel (14) and two side panels (15) separately hinged to the bottom panel (11). Together when each is latched they form a four sided polygon representing a quadrilateral with an accessible internal storage space (16).

In a second orientation, all panels are unlatched from the box shape (10) and hinged between top panel (12) and back panel (13) (not shown) with front panel (14) and two side panels (15) further hinged to bottom panel (11) with wheels (not shown) which open into a moveable contiguous flat surface exposing the inner surfaces of the panels and attached tools allowing access to a secured tool selection on each panel face.

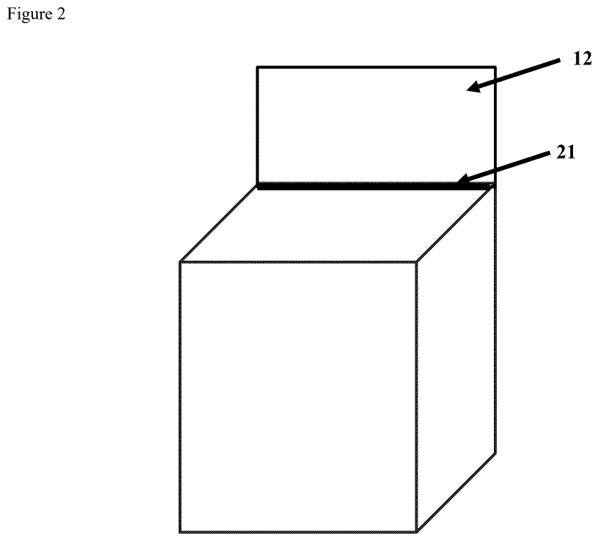

FIG. 1 depicts the first orientation in the closed formation where the tools are secured within the latched four-sided polygon with the top panel forming a closed and latched lid which is hinged to the back panel to allow complete closure. FIG. 2 shows an alternate position with only the lid in an open unlatched position with the same hinge (21) for access to the tools in the inner space while forming the four-sided polygon having the panels latched together.

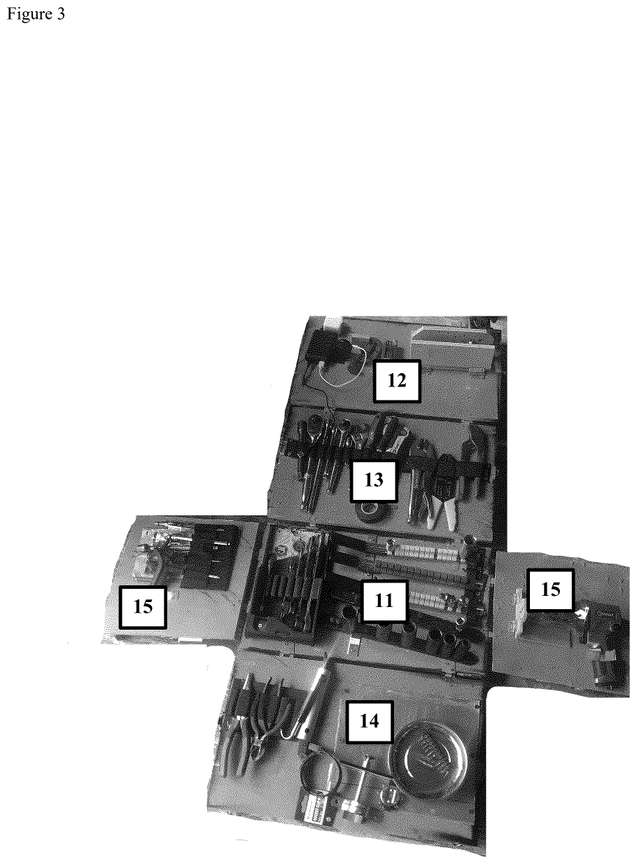

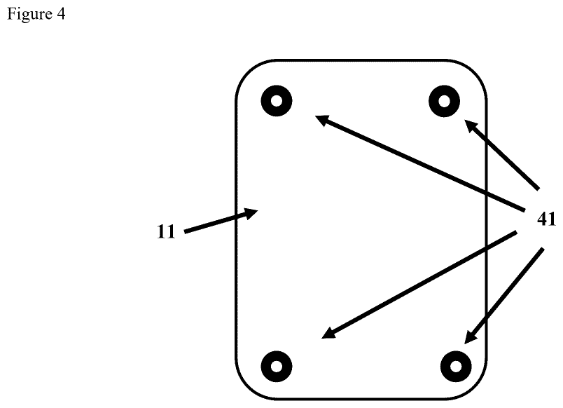

The bottom edges of the top panel hinged to the back panel and four-sided polygon hinged to the bottom panel such that when unlatched and opened as shown in FIG. 3 they form a contiguous flat surface where each inner surface of all the panels are opened and supported in a flat position through a hinged 90° rotation of the panels from their prior latched orientation. The second orientation allows access to selected tools secured on the panels inner surface through any appropriate attachment means such as, but not limited to, securing straps, fasteners, magnetic holders, Velcro, or any mechanical means to hold a desired object. FIG. 4 provides a further view of the wheel structure on the bottom panel needed on the underside for moving the toolbox when moving in either of the orientations described herein. Thus, when closed and latched, the toolbox can be guided along on four wheels (41) located on the underside of the bottom panel or when open and unlatched the entire contiguous flat surface can be repositioned along the working floor area by moving the panels with the same wheel formation on the underside of the bottom panel accordingly. The present invention is not limited to any specific type of wheel structure, however four-wheel casters in the four corners of the under surface of the bottom panel are preferred with swivel wheel casters to freely rotate about 360° which allows the wheels to roll in any direction. FIG. 4 represents a preferred location of the wheels.

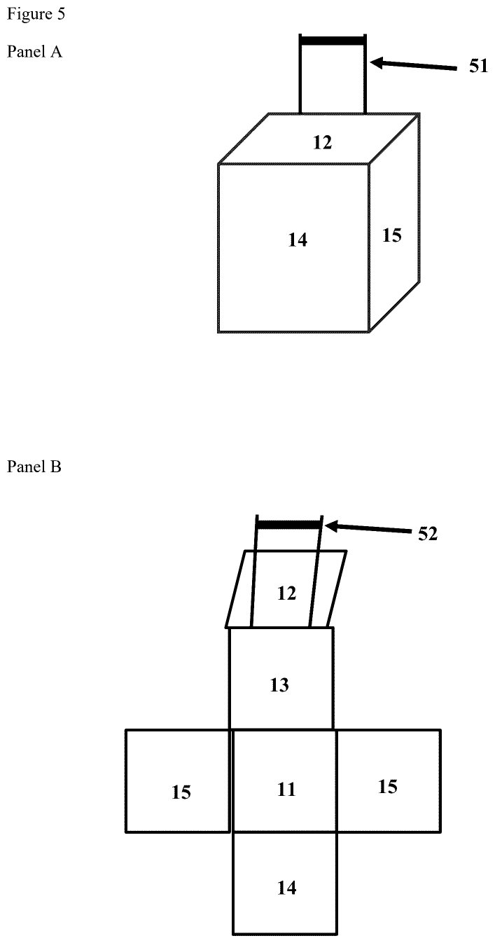

A further option includes a telescoping handle as shown in FIG. 5, Panel A depicts the telescoping handle (51) on the outside surface of the back panel to allow easy transport of the toolbox or optionally depicted in FIG. 5, Panel B having articulating handle (52) shafts to allow attachment of the lid or top panel when in the open orientation. This design incorporates a magnetic means within both handle shafts and a corresponding magnetic means on the outer surface of the top panel. Thus when the toolbox is opened to a 90° hinged position in the second orientation with the unhinged panels on the flat surface, the inner top surface is used as a viewing stand for an optional tablet computer device, discussed below.

Each panel includes a hard-shell composite to allow secure transport and movement in any orientation. While any composite is considered in the present invention. A preferred polycarbonate (PC) panel structure is considered which can be cast from transparent plastic or optionally colored in the production process. Another advantage of this composite is that it makes the panels virtually unbreakable and has high flexibility which when deformed can be brought back into shape. Another composite considered is acrylonitrile butadiene styrene (ABS). This is a very hard shell composite, making each panel stable, scratch resistant, and lightweight.

The coloring option on the outer surface for PC or ABS composite panels of the toolbox is applicable in an industry where color coding is needed to identify specific types of tool use. Specifically, color coding is appropriate in the medical or veterinary industry where, for example, a toolbox with a red colored outside surface signifies a toolbox needed for critical emergency tool use. In a still further option, the specific inside surface of a panel may represent a group of tools located within the inner space. For example, a toolbox containing two groups of ratchets and sockets with varying sizes can be designated by the color of the inner panel. An inner red panel having securing means on the surface for the imperial measurement system with standard sockets while a separate panel may have a blue color representing corresponding metric components secured to its surface.

Another embodiment of the present invention considers a toolbox in the second unlatched orientation with a moveable, contiguous and flat surface. The inner surface of the top panel contains a wireless portable media player (PMP) or digital audio player (DAP) secured therein for enjoying music while working and locating tools. This component provides known benefits for individual worker using the toolbox. Music makes working people feel good and are happy workers which are more likely to be focused and productive while using tools. The same embodiment is also considered when the toolbox is latched in a four-sided polygon.

A still further option is to incorporate a tablet computer device attached to the inner surface of the top panel or lid for viewing when the top panel is opened again unlatched in a moveable, flat surface orientation while working on a specific task that requires access to a tool selection. The tablet computer has connectivity to WiFi or is supported through cellular networks to allow access to internet instructional videos or demonstrations in real-time during work procedures. For example, a video showing needed tools for removal and replacement of an automobile water pump could be accessed through the internet, shown on the tablet computer screen and played during the actual repair work with access to required tools located within or displayed in the toolbox.

It will thus be seen that there has been provided by the present invention a alcohol gel-based outdoor portable stove set forth, together with many thoroughly practical advantages, has been successfully achieved. While a preferred embodiment of the present invention has been shown and described, it is to be understood that variations and changes may be resorted to without departing from the spirit of the invention as defined by the appended claims.

1. A toolbox comprising:
a. a top panel;
b. four side panels; and
c. a bottom panel with wheels, where a, b, and c are hinged in an open or closed orientation through a latching means.

2. The toolbox of claim 1 further having the bottom panel containing swiveling caster wheels.

3. The toolbox of claim 1 where a, b, and c are latched to form a mobile four-sided polygon in a quadrilateral for tool storage and access.

4. The toolbox of claim 1 where a, b, and c are unlatched to form a moveable, linear and flat surface.

5. The toolbox of claim 1 where the inner surface of the panels contains selected tools secured by an attachment means.

6. The toolbox of claim 4 where the attachment means is securing straps, fasteners, magnetic holders or Velcro.

7. The toolbox of claim 1 where the panels include a hard-shell composite.

8. The toolbox of claim 6 where the hard-shell composite is PC or ABS.

9. The toolbox of claim 1 where the outer surface of the back panel further contains a telescoping handle for moving the toolbox.

10. The toolbox of claim 1 where the inner surface of the top panel contains a wireless PMP or DAP.

11. The toolbox of claim 1 where the inner surface of the top panel contains a tablet computer capable of accessing the internet.
